(19) United States
(12) Patent Application Publication
(10) Pub. No.: US 2015/0207458 A1
(43) Pub. Date: Jul. 23, 2015

(54) FIBER COMPOSITE SOLAR PANEL FOR ELECTRICITY GENERATION AND HEAT COLLECTION

(71) Applicant: MONARCH POWER CORP, SCOTTSDALE, AZ (US)

(72) Inventors: Joseph Y. Hui, Fountain Hills, AZ (US); Ronan Reynolds, Scottsdale, AZ (US)

(73) Assignee: MONARCH POWER CORP, SCOTTSDALE, AZ (US)

(21) Appl. No.: 14/598,698

(22) Filed: Jan. 16, 2015

Related U.S. Application Data
(60) Provisional application No. 61/930,270, filed on Jan. 22, 2014.

(51) Int. Cl. H02S 40/44; H02S 20/22

(52) U.S. Cl. CPC H02S 40/44; H02S 20/22; H02S 20/32

(57) ABSTRACT

A building integrated photovoltaic and heat (BIPVAH) solar panel system whereby solar panels are layered into a laminate with a top photovoltaic composite layer, a middle heat exchanging fiber composite frame, and a bottom fiber composite layer. These three layers in turn form a composite structure for a strong and lightweight structure for the purposes of electricity and heat generation. The panels are strong and lightweight so as to provide a solution for shading structures such as awning, and a flower like solar tracking system that can close at night and under adverse climate conditions, etc.

### CLAIM OF PRIORITY

This application claims priority of U.S. Provisional Patent Application Ser. No. 61/930,270 entitled A FIBER COMPOSITE SOLAR PANEL FOR ELECTRICITY GENERATION AND HEAT COLLECTION filed Jan. 22, 2014, the teachings of which are included herein by reference in their entirety.

### BACKGROUND

Building Integrated Photovoltaic (BIPV) systems are emerging photovoltaic materials, which are built into the building or vehicle architecture. Solar energy is an important part of our biosphere. Photovoltaic technologies should be integrated into our environment with architectural flare. We have to build with people's need in mind, not just energy, but also beauty, comfort, simplicity, mobility, and flexibility.

We propose to build solar panels called Lotus Awning panels. The Lotus Awning solar panels are a basic BIPV system that gives people shade, portability, foldability, heat, and electricity. These panels are designed to be used as awnings as attachment to buildings.

We want strong, yet lightweight solar panels. Conventional solar panels are covered on top by glass and framed with aluminum. They are mounted rigidly on fixed structures that have to be put in places where people cannot reach such as on rooftops. We want the panels to withstand storms not just by strength but also by retracting. Beauty and brand are important, as much as usefulness.

Simplicity in buying, installing, maintaining servicing, and relocating solar panels is what people want. They don't just want heavy and ugly solar panels on a rooftop or in a solar farm. They want something they can touch, move, and see. They want to be able open these panels when the sun rises and to fold them when the sun sets.

The Lotus Awning uses solar panels in a foldable structure on the side of a building to give people shade, electricity, and hot water. That is much needed here in Arizona, where sun exposure can cause health hazards quickly. Yet people here prefer to eat and drink outside as a form of alfresco dining. Also, homes here tend to avoid a southerly exposure because that tends to increase house temperature. Awnings shading windows are a necessity to avoid heat.

In general there is a strong need to make rigid panels that are very lightweight, able to produce not only electricity but also to collect heat. The heat collection also reduces the temperature of the solar panels. High temperature reduces the efficiency of photovoltaic generation and also can cause degradation to the solar panel over time. Besides the Lotus Awning application, we are also using these composite panels for mobile applications such as solar charging of electric cars. We can also mount these composite panels on much larger solar panel systems that track the sun on two axes for another 40% increase of energy production. These panels are used for the Lotus Mobile, Lotus Heat, and Lotus Max systems for which a disclosure has been filed for an umbrella like folding of these solar panels during strong wind.

### SUMMARY

We invented a building integrated photovoltaic and heat (BIPVAH) solar panel system comprising solar panels comprising a top photovoltaic composite layer, a middle heat exchanging fiber composite frame, and a bottom fiber composite layer. These three layers in turn form a composite structure for a strong and lightweight structure for the purposes of electricity and heat generation. We use these panels as shading structures such as awning and a flower like solar tracking system that can close at night and under adverse climate conditions.

The present invention includes a lightweight solar panel that can collect both heat and solar electrical energy. The provision of the lightweight supported panels allows for new applications of solar panels, for instance as awnings, shade structures, or otherwise applications onto residential, commercial, and other structures. By placing the BIPVAH on a residential building, such as a home or apartment building, the panels can be mounted on one side as awnings. Preferably, the awnings can be swung from hinges mounted on the wall, to allow for deployment for shade, etc. as well as solar energy collection in the dual forms of heat (i.e. for a hot water heater) and electricity, i.e. through solar panels to power the home, and/or supply an electrical grid.

In one exemplary embodiment, we use a fluorocarbon top window for solar cells that are encapsulated by ionomer to adhere to both the top window and a bottom fiber glass composite layer. The resulting photovoltaic layer is glued onto a carbon fiber frame of rectangular tubes through which a coolant, preferably such as glycol, flows. A bottom layer of fiberglass composite sheet, as is known in the art, is glued onto the carbon fiber frame, making a strong composite of a solar panel of two strong composite sheets enclosing a strong carbon fiber frame. The resulting composite structure is lightweight and very strong to hold its weight and withstand wind force.

The solar panels can be mounted to the side of a building, such as on a wall, by means of brackets. The brackets can swing the orientation of the solar panels, such as to allow them to be brought down when unneeded, or for their protection. The panels can also be mounted on an eastern facing wall and track the sun as it rises, rotating along the hinge axis to first show to the east in the morning, rise parallel with the ground at noon, and continue to rise to track the sun to the west. For instance, the panels can begin at −90 (vertical) or preferably −60 degrees from the horizontal, rise to 0 degree at horizontal, and extend past +5 degrees and possibly towards preferably +60, if not +90 degrees (vertical) facing west.

### BRIEF DESCRIPTION OF THE DRAWINGS

For a more complete understanding of the present disclosure and its advantages, reference is now made to the following description taken in conjunction with the accompanying drawings, in which like reference numerals represent like parts, wherein:

FIG. 1 shows an exploded view of the constituent layers of the composite panel of a preferred embodiment of the present invention;

FIG. 2 shows the back side of a solar panel of the present invention assembled, laminated, and framed;

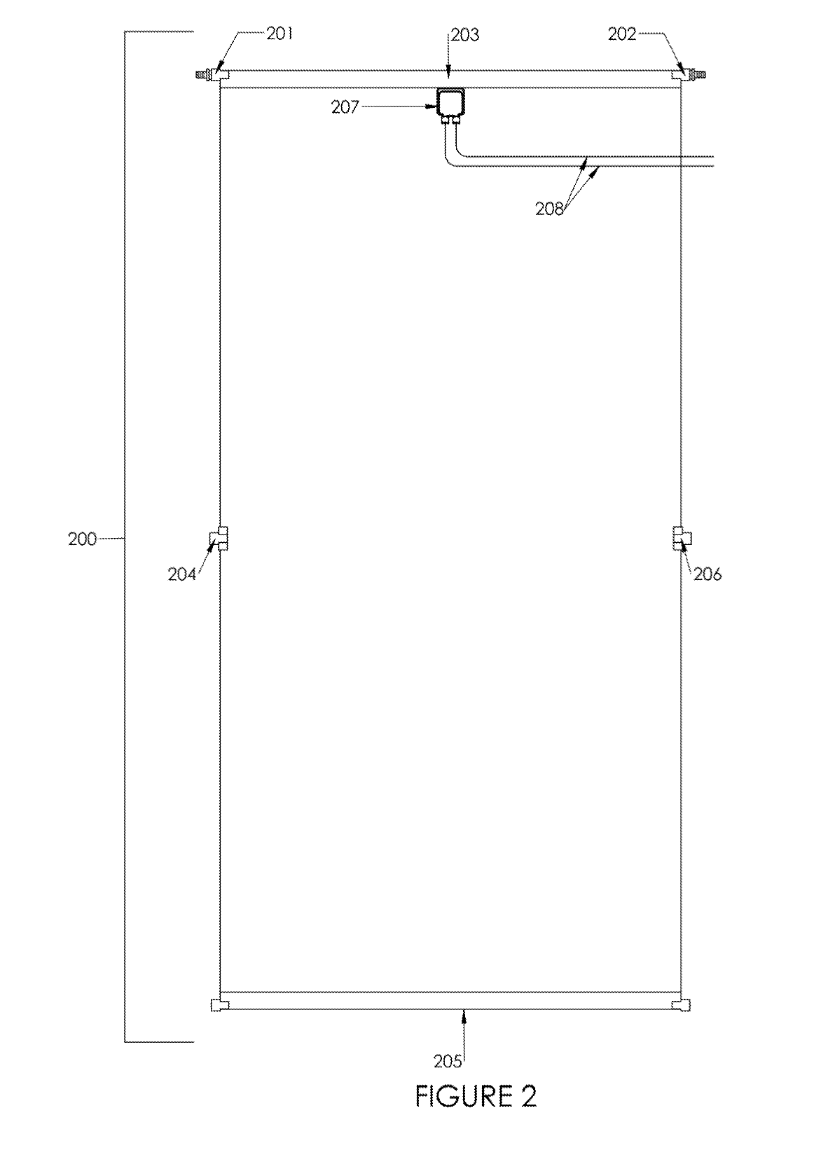

FIG. 3 shows a preferred embodiment of the carbon fiber frame for structural support and for heat collection;

FIG. 4 shows a preferred embodiment of the carbon fiber frame demonstrating how a coolant circulates in the frame for heat collection;

FIG. 5 shows a preferred embodiment of a bib connector connecting sections of carbon fiber tubes in the present invention;

FIG. 6 shows a series of two panels with coolant circulation and electricity connections of the present invention;

FIG. 7 shows a preferred embodiment of the present invention including a system whereby electricity inversion to electric panel and coolant flow to water heater.

### DETAILED DESCRIPTION

This disclosure provides a new method and apparatus of a fiber composite solar panel that produces photovoltaic electricity and collects solar thermal energy by means of an integrated composite structure which is lightweight, strong, and easy to fold. U.S. Patent Publ. No. 2013/0327371 entitled Foldable Solar Power Receiver, filed Jan. 16, 2013 is hereby incorporated by reference.

The preferred fiber materials we use include but are not limited to, fiberglass and carbon fiber. Other polymers and materials known in the art to have sufficient strength and similar features of these materials are also acceptable for the present invention.

The preferred polymers we use, include but are not limited to, polytetrafluoroethylene (PTFE) to replace glass as window for solar cells, ionomer or ethylene-vinyl acetate (EVA) as adhesives, as well as polypropylene, polyethylene, or epoxy as fiber reinforced polymer.

The preferred photovoltaic materials we use include but are not limited to mono-crystalline silicon cells, poly-crystalline silicon cells, and other thin film solar cells such as those based on amorphous silicon, cadmium telluride, and copper-indium-gallium-selenium (CIGS).

We disclose manners of layering these materials together to build a strong composite structure based on the use of adhesives, heat and pressure lamination, as well as clamping.

We disclose how the laminated panel structure is designed for lightweight, while having high tensile strength to handle its weight and wind load. We increase or build the depth of the laminated structure through a fiber composite frame using a small amount of strong material such as carbon fiber. The stiffness of the panel is based on the use of fiber composite sheet sandwiching a hollow carbon fiber frame of sufficient thickness. The entire structure is an integrated composite for both electricity and heat collection. In the prior art, most heat collecting systems are an add-on to existing solar panels, which are heavy and increase the load requirement of supporting structure rather than adding strength to the system.

The present invention includes a coolant circulated within the laminated solar panel structure, for cooling the solar panel and for heat collection for the purposes of water and space heating. The coolant runs directly in carbon fiber tubes underneath the solar cells, or solar cell layer. The coolant cools the solar cells which has an added benefit for increased electricity production. The use of carbon fiber tubes is preferred as it is very strong and also a very good conductor of heat.

The present invention includes panels that are preferably mounted and propped up against the side of a building. Thereby the panels could be folded at night or during strong wind. These lightweight panels could be folded like an umbrella or as a deck to avoid wind force.

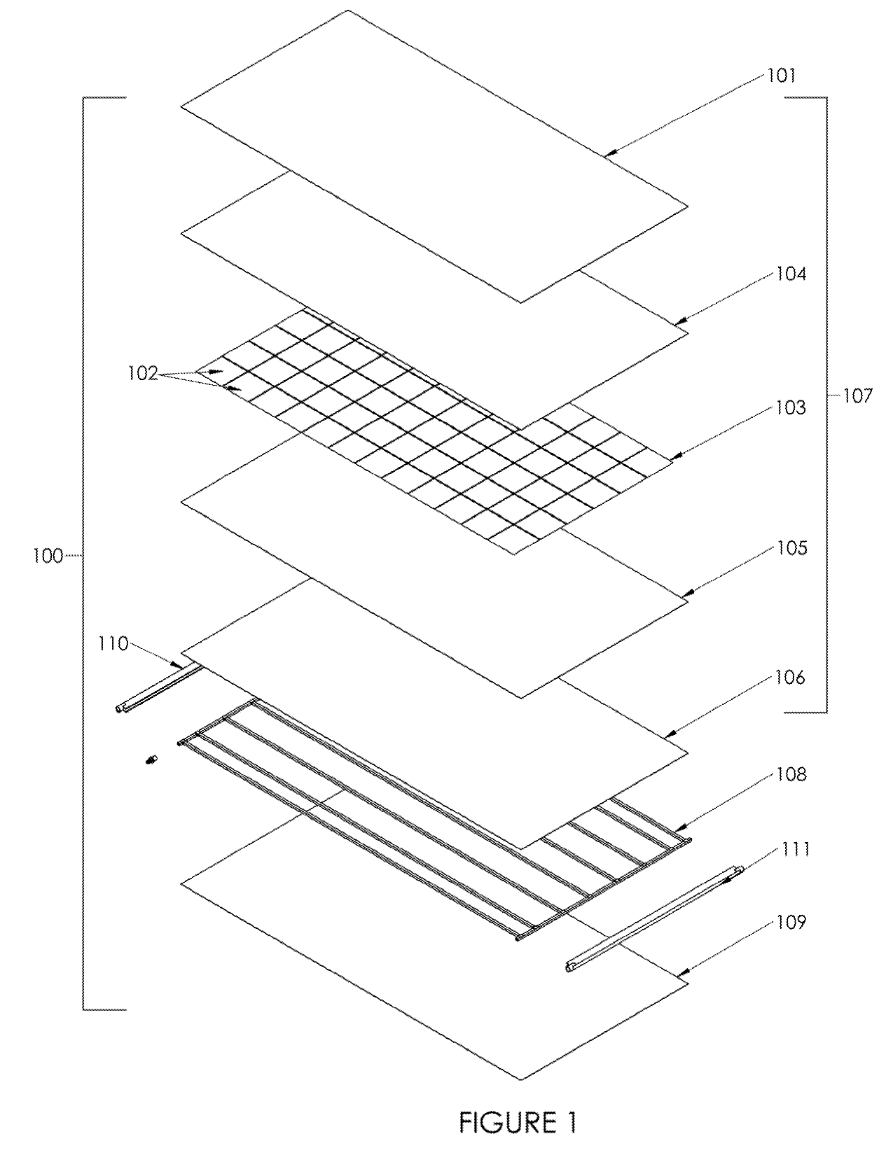

The individual layers 100 of this composite structure are shown in FIG. 1 from top (the photovoltaic side) to the center (heat collection manifold) and the bottom covering sheet of fiber composite. These layers are to be laminated in multiple steps to form a solar panel.

The top transparent layer 101 protects the solar panel from outside elements such as water, wind, hail, and other impacting objects. The material is preferably a strong transparent layer, such as PTFE, that prevents abrasion, water infusion, tear, heat and light degradation, electric breakdown, and soiling by dust and rain.

The solar cells 102 are positioned in an array and are connected in series by tabbing wires (as is known in the art), forming the photovoltaic layer 103. These cells are encapsulated in two layers of encapsulants top encapsulant 104 and bottom encapsulant 105 by adhesives such as ionomer or EVA or other encapsulants known in the art. The encapsulant layer 104 also serves as an adhesive for the solar cells to adhere to the window layer 101.

A composite layer 106, preferably a fiberglass sheet, is preferably embedded in a polypropylene or nylon polymer and provides back sheet support for the photovoltaic layer 103. The encapsulant layer 105 also serves as an adhesive for the solar cells to adhere to the composite layer 106.

After these layers 101-106 are assembled, the assembly is laminated by heat and pressure to form one single laminated composite layer labeled as 107. We call the composite layers 101, 103, 104, 105, and 106 the photovoltaic composite layer 107. It is preferred that heat pressure is accomplished at an appropriate temperature to ensure proper adhesive and chemical and property changes while not raising the temperature too high to weaken the polypropylene sheet. While the solar cells can withstand temperatures over 300 degrees Celsius, it is preferred to combine the laminate at approximately 140 degrees Celsius, but not higher than 180 degree Celsius, due to potential degradation of the layer materials and to avoid unnecessary deformation.

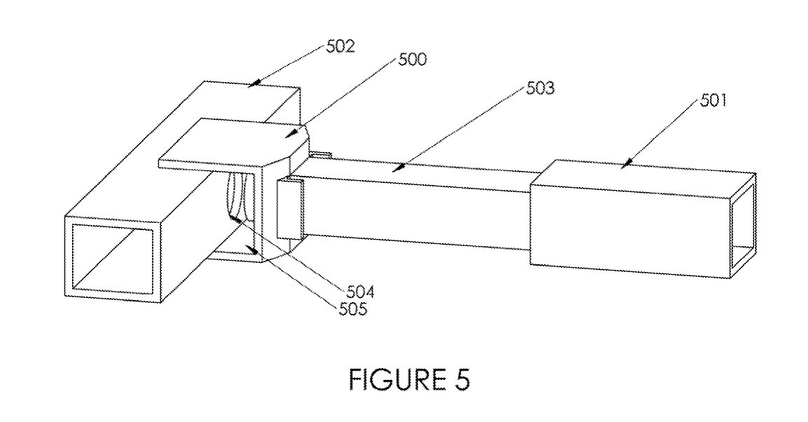

The frame 108 is preferably formed of carbon fiber composite. The frame preferably includes as many lengths of hollow carbon fiber rods with rectangular cross sections. These lengths are joined together using bibs (as shown in FIG. 5, reference 500). Preferably, frame includes of carbon fiber set in epoxy. In an alternative embodiment, frame may be made from other fiber such as glass fiber and/or polymer such as polyethylene, and other material known in the art to provide similar support and heat conduction. The purposes of the frame are to provide both structural support and a fluid flow manifold for heat exchange. Frame 108, forms the middle layer of the laminate composite solar panel of the present invention.

The bottom layer of the entire assembly is preferably made of another fiber composite layer 109. This composite layer 109 together with the laminated photovoltaic top layer 107 sandwich the carbon fiber composite frame 108. We use a strong adhesive, such as silicone, to form a strong single laminate of the layers 107, 108, and 109 to form a solar panel 100. We add two aluminum frames 110 and 111 at both ends of the solar panel 100 for the purpose of attaching the solar panel 100 to the wall (not shown).

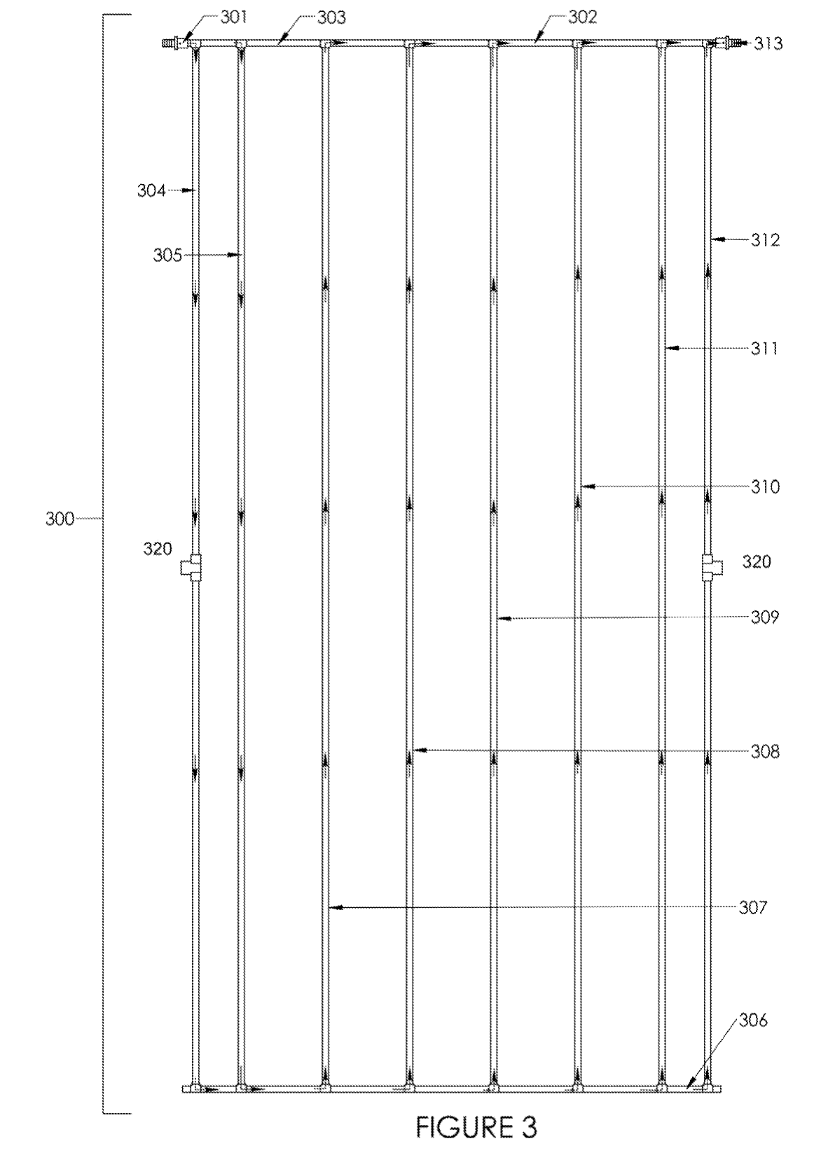

FIG. 3 demonstrates a preferred embodiment of the laminated and framed solar panel 200 of the present invention. Additional structure includes two bibs 201 and 202 for attaching glycol hose 203, and clamps 204 and 206 at other locations of the panel. The junction box 207 terminates either ends of the series of solar cells and connects through an external wire 208 to other panels or inverters (not shown). Bottom U-channel clamp 205 further supports laminated structure and further hold the laminate layers together, while simultaneously providing extra support to the walls and props.

FIG. 3 shows the carbon fiber frame 300 indicating the routing of coolant in the manifold. In the preferred embodiment shown in FIG. 3, glycol enters frame 300 through the top left bib 301. The top carbon fiber tube 302 is preferably blocked at 303 to direct glycol through additional tubing and preferred path. Pivots 320 support the panels by the prop rods.

The glycol flows down two carbon fiber tubes 304 and 305 towards bottom carbon fiber tube 306. Glycol flows through tubes 304 and 305 to bottom tube 306 and is then distributed as cool glycol up carbon fiber tubes 307, 308, 309, 310, 311, and 312. In our implementation, the tubes 307, 308, 309, 310, and 311 are located at the center of the six columns of solar cells, providing best support to the cell and central dissipation of heat from the cell.

Glycol routed upward through these tubes collects heat from solar cells. Glycol is collected at the top tube 302 and routed out through bib 313. Directional flow of fluid in these tubes is indicated by arrows.

Rods 304, 305, 307, etc. should be spaced so as to run along the center of each solar cell, so as to properly collect the heat from the appropriate areas. By pulling directly adjacent to cells, the heat dissipation from the cells is increased and therefore further increases the beneficial impact of keeping the solar cells cooled for electrical generation efficiency. Typically the tubes are placed between 4 and 8 inches apart, preferably just over 6 inches, or more preferably spaced 6.4 inches apart.

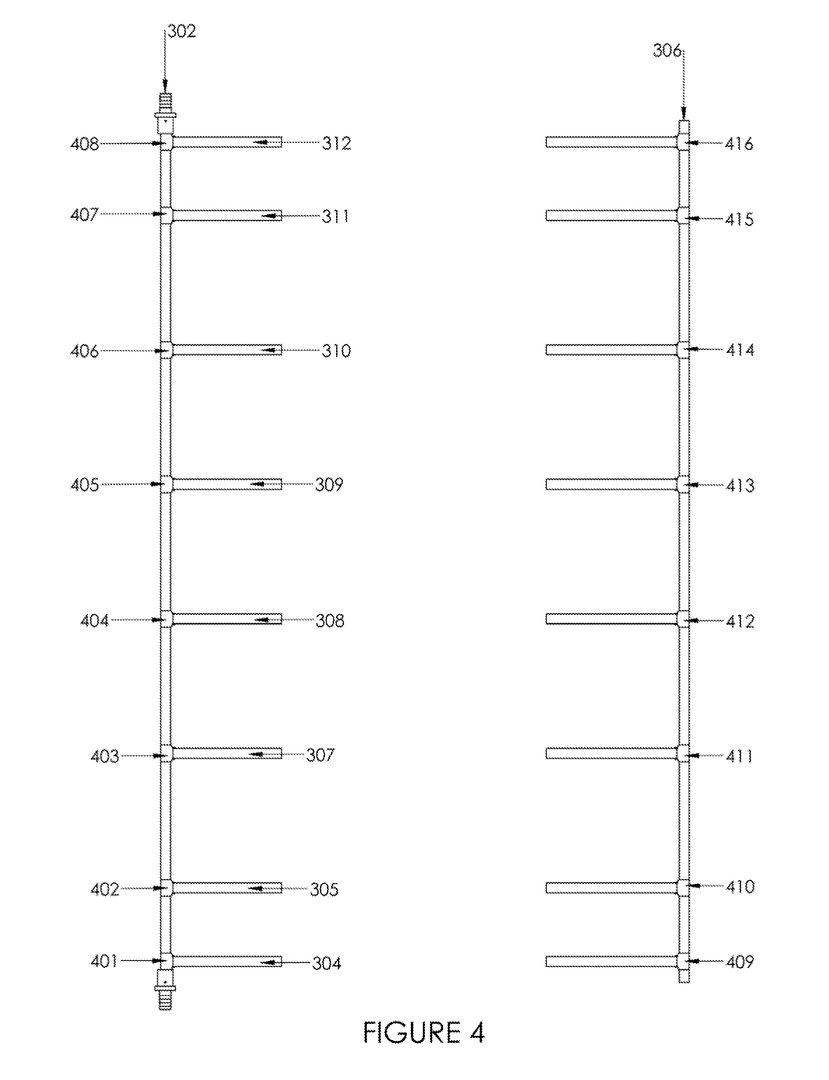

FIG. 4 shows the bibs 401-416 connecting eight vertical carbon fiber tubes 304, 305 307-312 to the two horizontal tubes 302 and 306. The length of vertical tubes is abridged and not to scale of the preferred embodiment.

FIG. 5 shows the detailed structure of a bib connector 500 of a preferred embodiment of the present invention. The term “bib” here is used in this application in a specific fashion to indicate the novel bib-like connector geometry that attaches elongated hoses, or tubing, or rigid hollow framed-tubes to either external feeds or one another, either via end connection and/or via side connection. Bib 500 connects various tubing while preventing leaks. For instance, bib 500 can connect a vertical tube (section) 501 to a horizontal tube (section) 502. The bib may include a T-joint 503 that extends in one direction of bib to insert inside the, preferably vertical, tubes to allow glycol to flow into the, preferably horizontal, tube through hole 504. In other words, bib 500 acts as a T-joint, with an extension 503 that is inserted into a tube to prevent leaking. To prevent leaking of glycol, the bib connector wraps around the horizontal tube with a U-clamp 505, which is then glued to the horizontal tube. Hollow boss 507 extends into hole 504 to ensure proper fit. Wings 508 allow for the insertion and isolation of tube 501 when paced upon T-joint 503, and tube 501 edge 509 fits in recess 510 created between wings 508 and T-joint 503. The entire bib 500 includes all shown and diagramed in FIG. 5, with the exception of the sections of tubing 501 and 502. The specific orientation and build design of the bib are a preferred part of an embodiment of the present invention. The clamp also provides good structure support at the junction. The bib connector is preferably made using resin transfer molded carbon fiber mixed with epoxy glue, the same materials that may be preferably used in the carbon fiber tube. The preferable gluing of the bib connector onto the tubes can be done preferably using epoxy.

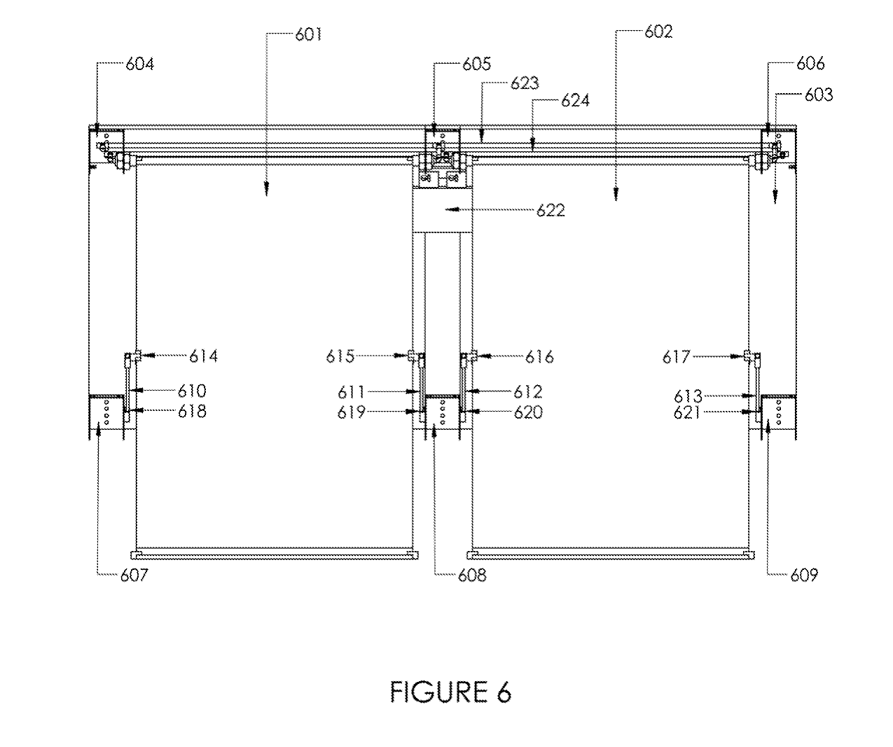

FIG. 6 shows how two solar panels 601 and 602 are attached to the side of the building 603. Attachment may be achieved by U-brackets 604, 605, and 606. These brackets preferably anchor into the structural beams of the building, and may be preferably set apart approximately 16-20 inches. Bottom U-brackets 607, 608, and 609 may also anchor into the structural beams of the building. These bottom brackets provide support to props 610, 611, 612, and 613 that support each panel midway at hinges 614, 615, 616, and 617. The top brackets allow the panel to be folded downward while the bottom brackets counter the weight. Brackets provide support along the length of the panel being retractable when the panels are folded. Preferably, the awning comprised of the laminated solar panels are hingedly coupled to the wall, preferably an eastern facing wall. The panels could be lifted, either by wind or manually so that the props may fall out of sockets 618, 619, 620, and 621 to allow the panels to fold downward by its own weight. The panels can be hingedly coupled to swing up from against a wall (when in vertical position), to upwards facing (horizontal), such as when the sun is directly overhead, i.e. noon. When the panels are situated towards the top of a structure, the panels can further swing above the horizontal to track the sun as it sets. By doing so, the panels can track the sun as it rises in the east, reaches zenith, and sets in the west, providing additional time and maximum exposure to increase total energy generation.

FIG. 6 also shows how the panels are connected to a micro-inverter 622 in the between the panels. Hot glycol conduit 623 and cool glycol conduit 624 may be shared by the panels from where they route out heated glycol and route in cooled glycol.

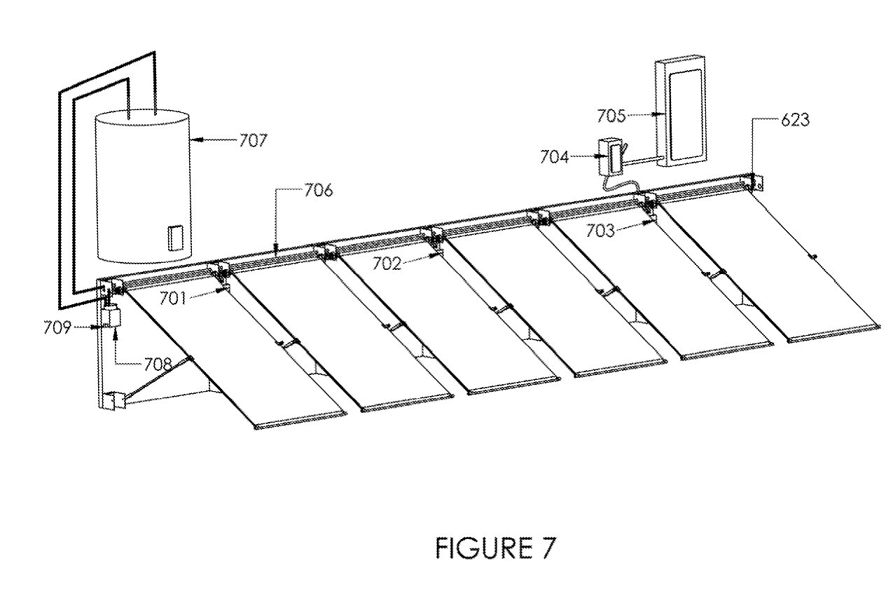

FIG. 7 shows the wire connections from a 6 panel system with multiple micro-inverters 701, 702, and 703 with AC output connected in parallel to an electric shut off switch 704. The electricity is then fed into an electric panel 705.

FIG. 7 also shows the flow of the hot glycol from conduit 623 through, preferably insulated copper, tubes 706 to exchange heat at the hot water tank 707. After a heat exchanger, the cooled glycol may return to a glycol sump bottle 708. A small glycol pump 709 submerged in the sump bottle is preferably powered by the DC electricity from one or more of the panels. Thereby it is preferably that the glycol cycles only when the sun shines at the time it is needed to cool the panels for electrical generation.

Modifications, additions, or omissions may be made to the systems, apparatuses, and methods described herein without departing from the scope of the invention. The components of the systems and apparatuses may be integrated or separated. Moreover, the operations of the systems and apparatuses may be performed by more, fewer, or other components. The methods may include more, fewer, or other steps. Additionally, steps may be performed in any suitable order. As used in this document. “each” refers to each member of a set or each member of a subset of a set. To aid the Patent Office, and any readers of any patent issued on this application in interpreting the claims appended hereto, applicants wish to note that they do not intend any of the appended claims or claim elements to invoke paragraph 6 of 35 U.S.C. Section 112 as it exists on the date of filing hereof unless the words “means for” or “step for” are explicitly used in the particular claim.

We claim:

1. A building integrated photovoltaic and heat generation apparatus for generating photovoltaic solar electricity and collecting solar heat comprising:
a) a first top layer comprising at least one material for photovoltaic generation;
b) a second middle layer comprising a hollow frame for routing at least one heat exchange fluid; and
c) a third bottom layer comprising a base layer;
whereby said first top and third bottom layers adhere to said second middle layer.

2. The building integrated photovoltaic and heat generation apparatus of claim 1, said first top layer further comprising:
a transparent window of a polymer; and
at least one solar cell below said transparent window, said at least one solar cell encapsulated by a polymer.

3. The building integrated photovoltaic and heat generation apparatus of claim 1, said second middle wherein said hollow frame comprising at least one hollow rectangular tube; said tube providing a manifold for routing at least one heat exchange fluid.

4. The building integrated photovoltaic and heat generation apparatus of claim 1, said third bottom layer comprising a closure around at least a portion of said second middle layer, said third layer interacting with said first top layer so as to form a compound composite laminate.

5. The building integrated photovoltaic and heat generation apparatus of claim 1, wherein said first top photovoltaic layer comprises a transparent layer of fluorocarbon present above said at least one material for photovoltaic generation.

6. The building integrated photovoltaic and heat generation apparatus of claim 1, wherein said second middle layer frame comprises:
at least one rectangular tube connected to at least a second tube by means of at last one bib connector, said first and second tubes providing structural support for said first top layer.

7. The building integrated photovoltaic and heat generation apparatus of claim 6, wherein said bib connector comprises:
a first intrusion piece extending therefrom for insertion into said tube;
a second intrusion piece extending therefrom for insertion into a second tube; and
at least one flange accompanying each of said first and second intrusion pieces to prevent leaks of heat exchange fluid.

8. The building integrated photovoltaic and heat generation apparatus of claim 7, wherein said first intrusion piece comprises a rectangular piece extended from said bib connector for mating within at least one rectangular tube, said first intrusion piece comprising an exterior perimeter matching the interior perimeter of said at least one rectangular tube.

9. A method for generating photovoltaic solar electricity and collecting solar heat comprising the steps of:
preparing a first transparent layer, over a material for photovoltaic generation;
preparing a second frame layer comprised of hollow tubing and mounting said first layer on top of said second layer;
preparing a third base layer and mounting said second frame layer on top of said third base layer;
heat combining said first, second, and third layers in to a single composite solar panel laminate, whereby said second frame layer is accessible via at least one hollow tube;
routing a heat exchange fluid through said second frame layer via the exposed hollow tube.

10. The method for generating photovoltaic solar electricity and collecting solar heat of claim 9, further comprising the step of collecting electricity and heat in tandem from the composite solar panel laminate.

11. The method for generating photovoltaic solar electricity and collecting solar heat of claim 9, further comprising the step of mounting the laminate solar panels at a first edge onto a wall.

12. The method for generating photovoltaic solar electricity and collecting solar heat of claim 9, wherein the step of routing comprises routing the heat exchange fluid by means of connectors interconnecting the at least two tubes.

13. The method for generating photovoltaic solar electricity and collecting solar heat of claim 12, further comprising the step of plugging at least one tube to direct flow within the second frame layer.

14. The method for generating photovoltaic solar electricity and collecting solar heat of claim 9, further comprising the steps of:
drawing the heat exchange fluid from a sump of cool fluid towards the collecting frame; and
returning heated heat exchange fluid to a heat exchanger.

15. The method for generating photovoltaic solar electricity and collecting solar heat of claim 14, wherein said heat exchanger includes a water tank.

16. A method of collecting solar energy comprising the steps of:
mounting a solar panel at an edge of the solar panel to a wall via hinges oriented north-south axis;
rotating the solar panel from an easterly facing direction around the hinge axis to a direction facing directly upwards;
rotating further the solar panel from the upwards facing direction to a westerly facing direction to track the sun as it sets.

17. The method of claim 16, whereby the westerly facing direction is at least 5 degrees off of the horizontal.
